(19) United States
(12) Patent Application Publication
(10) Pub. No.: US 2010/0121066 A1
(43) Pub. Date: May 13, 2010

(54) Novel Process For Preparing Risedronic Acid

(76) Inventors: Tavhare M. Ankush, Mumbai (IN); Kumar Rajiv, Mumbai (IN); Telang Ramesh Baburao, Mumbai (IN)

Correspondence Address: George W. Moxon II;Moxon & Spriegel, 110 West Streetsboro Road, Suits L 9 & 11-13, Hudson, OH, 44236, US

(21) Appl. No.: 12/688,465

(22) Filed: Jan. 15, 2010

(30) Foreign Application Priority Data
Jun. 20, 2007 (IN) APPL1196/MUM/2007
Jun. 20, 2008 (IN) PCT/IN2008/000039

(51) Int. Cl. C07F 9/38

(52) U.S. Cl. 546/22

(57) ABSTRACT

The present invention relates to a process for preparing risedronic acid comprising the step of combining a 3-pyridyl acetic acid or a salt thereof, phosphorous acid, and a halophosporous compound selected from PCl₃, PCl_{S}, POCl₃, PBr₃, POBr₃, and PBr₅ in the presence of a diluent that is either a bicyclic aliphatic hydrocarbon or a substituted cyclic aliphatic hydrocarbon or a mixture thereof, in combination with a codiluent, that is orthophosphoric acid

### FIELD OF THE INVENTION

The present invention relates to a novel process for preparing risedronic acid and its pharmaceutically acceptable salts.

### BACKGROUND OF THE INVENTION

Risedronic acid belonging to bisphosphonate family, is chemically known as [1-hydroxy-2-(3-pyridinyl)ethylidene]bisphosphonic acid and has the general structure represented by Formula (I). Its monosodium salt i.e. sodium Risedronate having general structure represented by Formula (II) is marketed under brand name Actonel® in the United States of America. It is useful in the treatment of osteoporosis and Paget's disease. It is also used in the treatment of postmenopausal osteoporosis and particularly used to reduce the risk of vertebral body fracture and femoral neck fracture. Another known use is for treating women and men with osteoporosis resulting from the use of long-term steroid medications or for preventing osteoporosis related steroid use.

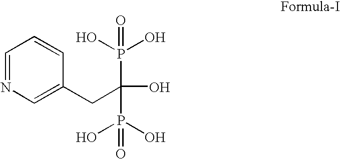

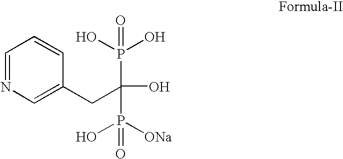

The synthesis of risedronic acid was first disclosed in European Patent No. 0186405 involving the reaction of 3-pyridyl acetic acid with phosphorous acid along with phosphorous trichloride using chlorobenzene as diluent. The diluent is removed from the reaction mass by decantation followed by isolation of product. But the operation disclosed is not feasible on plant scale and the yield is low.

U.S. Pat. No. 4,407,761 discloses a process for preparing bisphosphonic acids from aminocarboxylic acid and phosphonating reactant in presence of halogenated hydrocarbons as diluents. But use of halogenated hydrocarbons has many disadvantages such as solidification; reactor fouling, making the process non-amenable to large scale.

U.S. Pat. No. 4,922,007 discloses a process for preparing bisphosphonic acid using methanesulfoic acid as diluent, which solublizes the reaction product and keeps reaction fluid, up to completion of reaction; and eliminates the problems with physical characterization of reaction. Methanesulfonic acid (MSA) is used to solubilize the reaction components and keep the reaction mixture stirrable up to completion of the reaction. The optimum temperature of phosphonylation reactions using phosphorus trichioride is 90° C. or high. Although the problems with physical characteristics of the reaction appeared solved, a safety problem surfaced. Methanesulfonic acid reacted with phosphorus triciriloride and under adiabatic conditions, i.e. above 85° C., the reaction mixture become uncontrollably exothermic, which is accompanied by high pressure and, therefore, is not very safe on large-scale production.

United States Patent Application No. 20040043967 A1 describes the preparation of bisphosphonic acids by using the diluents other than halogenated hydrocarbons, but overall yield of the process is 56% to 80%.

U.S. Pat. No. 6,562,974 describes the preparation of bisphosphonates in an overall yield of 77% by using phosphorous acid as a reactant/solvent in presence of base. The disadvantage of this process is that the reaction mixture becomes very viscous without a solvent.

U.S. Pat. No. 7,038,083 ('083 patent) discloses a process for preparing bisphosphonic acid derivatives including risedronic acid comprising the steps of condensation of (3-pyridyl)ethanoic acid or its hydrochloride with phosphorous acid and halophosphorus acid in presence of aromatic hydrocarbons such as toluene as diluent and orthophosphoric acid as co-diluent; followed by hydrolysis and then precipitation of the product. It is well known that toluene contains traces of benzene which is class-I solvent having the limit of 2 ppm as per International Conference on Harmonization (ICH) guidelines. It is practically quite difficult and troublesome to control benzene at this level. Also aromatic hydrocarbons are generally to be used only in low limits as solvents as per ICH and therefore their handling and usage is tedious.

PCT Application No. 2006134603A1 ('603 application) discloses the process for producing bisphosphonic acids and salts thereof. The process involves the reaction of a carboxylic acid with phosphorous acid and halophosphorus compound in the presence of a solvent selected from aliphatic hydrocarbon or water miscible cyclic ether. This invention also provides novel forms of bisphosphonic acids and process for preparation thereof. This process uses linear or branched or cyclic aliphatic hydrocarbons such as n-hexane, octane, iso-octane, cyclooctane, cyclohexane, heptane and cycloheptane. These aliphatic hydrocarbons generally have low boiling points, are more volatile, and have low flashpoints resulting in hazards for handling and less recovery. Also some of the aliphatic hydrocarbons solvents which are having higher boiling points, have lower limits as per ICH, making their handling and usage tedious. Additionally the process disclosed in this application does not use orthophosphoric acid which could lead to lower quality and yield of product and fouling of the reactor during operation.

The literature survey reveals that several diluents e.g. fluorobenzene, diphenyl oxide, methane sulphonic acid, methane sulphonic anhydride, sulpholane and the like have been used by different innovators, but in all the case yield is low as well as process operations are not feasible on plant scale.

Thus the prior art process of preparation of risedronic acid in the '083 patent has the disadvantages in using aromatic hydrocarbons such as toluene or chlorinated aromatic hydrocarbon like chlorobenzene as solvent. Toluene contains traces of benzene which is class-I solvent having the limit of 2 ppm as per ICH and it is practically quite difficult and troublesome to control benzene at this level. Also aromatic hydrocarbons are to be used only in low limits as solvents, as per ICH and therefore their handling and usage is tedious. Similarly prior art process of the '603 application discloses process for producing bisphosphonic acids involving the reaction of a carboxylic acid with phosphorous acid and halophosphorus compound in the presence of a solvent selected from linear or branched or cyclic aliphatic hydrocarbons or water miscible cyclic ether. The aliphatic hydrocarbons generally have low boiling points, are more volatile, and have low flashpoints resulting in hazards for handling and less recovery. Also some of the aliphatic hydrocarbon solvents which are having higher boiling points have lower limits as per ICH, making their handling and usage tedious. Additionally the process disclosed in this application does not use orthophosphoric acid which could lead to lower quality and yield of product and fouling of the reactor during operation.

Hence there is a need for a process for preparing risedronic acid, which avoids the use of aromatic hydrocarbons as diluent or branched aliphatic or cylic aliphatic hydrocarbons as solvents. The present invention provides a solution to these problems by using a diluent that is either a bicyclic aliphatic hydrocarbon or a substituted cyclic aliphatic hydrocarbon or a mixture thereof in combination with a codiluent, that is orthophosphoric acid. It was found by the present inventors that the use of a bicyclic aliphatic hydrocarbon or a substituted cyclic aliphatic hydrocarbon along with orthophosphoric acid provides a process which is cost-effective, ecofriendly and can be commercialized on a large scale with no prior art disadvantages of recovery or handling of the solvents or reactor fouling.

### OBJECT OF THE INVENTION

It is an object of the present invention to provide a process for preparing risedronic acid.

It is further object of the present invention to provide a process for purification of risedronic acid

It is further object of the present invention to provide a process for preparing risedronic acid of high purity.

It is still further an object of the present invention to provide a process for preparing risedronic acid, eliminating the use of aromatic hydrocarbons and linear or branched or cyclic aliphatic hydrocarbons.

It is still further an object of the present invention to provide a process for the preparation of risedronic acid, which is cost-effective, ecofriendly and can be commercialized on a large scale with no prior art disadvantages of recovery or handling of the solvents or reactor fouling.

It is still further an object of the present invention to provide a process for the preparation of a salt of risedronic acid.

At least one of the preceding objects is met, in whole or in part, by a process for preparing risedronic acid comprising the step of combining a 3-pyridyl acetic acid or a salt thereof, phosphorous acid, and a halophosporous compound selected from PCl₃, PCl_{S}, POCl₃, PBr₃, POBr₃, and PBr₅¹ in the presence of a diluent that is either a bicyclic aliphatic hydrocarbon or a substituted cyclic aliphatic hydrocarbon or a mixture thereof, in combination with a codiluent, that is orthophosphoric acid.

### SUMMARY OF THE INVENTION

According to an aspect of the present invention is provided a process for preparing risedronic acid.

According to another aspect of the present invention is provided a process for purification of risedronic acid.

According to another aspect of the present invention is provided a process for preparing risedronic acid of high purity.

According to another aspect of the present invention is provided a process for preparing risedronic acid, eliminating the use of aromatic hydrocarbons and linear or branched or cyclic aliphatic hydrocarbons.

According to another aspect of the present invention is provided a process for the preparation of risedronic acid which is cost-effective, ecofriendly and can be commercialized on a large scale with no prior art disadvantages of recovery or handling of the solvents or reactor fouling.

According to another aspect of the present invention is provided a process for the preparation of a salt of risedronic acid.

According to an aspect of the present invention is provided a process for preparing risedronic acid comprising the step of combining a 3-pyridyl acetic acid or a salt thereof, phosphorous acid, and a halophosporous compound selected from PCl₃, PCl_{S}, POCl₃, PBr₃, POBr₃, and PBr₅ in the presence of a diluent that is either a bicyclic aliphatic hydrocarbon or a substituted cyclic aliphatic hydrocarbon or a mixture thereof, in combination with a codiluent, that is orthophosphoric acid.

According to another aspect of the present invention is provided a process for preparing a salt of risedronic acid comprising the steps of
(a) combining a 3-pyridyl acetic acid or a salt thereof, phosphorous acid, and a halophosporous compound selected from PCl₃, PCl_{S}, POCl₃, PBr₃, POBr₃, and PBr₅ in the presence of a diluent that is either a bicyclic aliphatic hydrocarbon or a substituted cyclic aliphatic hydrocarbon or a mixture thereof, in combination with a codiluent, that is orthophosphoric acid to form a reaction mixture;
(b) hydrolyzing the reaction mixture obtained in (a);
(c) optionally adding an alcohol to said reaction mixture to precipitate risedronic acid;
(d) purifying the risedronic acid.

The invention may be summarized as given below:
A. A process for preparing risedronic acid comprising the step of combining a 3-pyridyl acetic acid or a salt thereof, phosphorous acid, and a halophosporous compound selected from PCl₃, PCl_{S}, POCl₃, PBr₃, POBr₃, and PBr₅ in the presence of a diluent that is either a bicyclic aliphatic hydrocarbon or a substituted cyclic aliphatic hydrocarbon or a mixture thereof, in combination with a codiluent, that is orthophosphoric acid.
B. The process as in A above, wherein the 3-pyridyl acetic acid salt is either an inorganic salt or an organic salt.
C. The process as in B above, wherein the 3-pyridyl acetic acid salt is a hydrochloride salt.
D. The process as in A above, wherein the bicyclic aliphatic hydrocarbon is selected from the group comprising decalin, tetralin and the like and mixtures thereof
E. The process as in A above, wherein the substituted cyclic aliphatic hydrocarbon is selected from the group comprising methyl cyclohexane, trans-dimethyl cyclohexane, cis-dimethyl cyclohexane and the like and mixtures thereof.
F. The process as in D above, wherein the bicyclic aliphatic hydrocarbon is decalin.
G. The process as in E above, wherein the substituted cyclic aliphatic hydrocarbon is methyl cyclohexane.
H. The process as in A above, comprising the steps of
   (a) combining a 3-pyridyl acetic acid or a salt thereof, phosphorous acid, and a halophosporous compound selected from PCl₃, PCl_{S}, POCl₃, PBr₃, POBr₃, and PBr₅ in the presence of a diluent that is either a bicyclic aliphatic hydrocarbon or a substituted cyclic aliphatic hydrocarbon or a mixture thereof, in combination with a codiluent, that is orthophosphoric acid
   (b) hydrolyzing the reaction mixture obtained in (a);
   (c) optionally adding an alcohol to said reaction mixture to precipitate risedronic acid;
   (d) purifying the risedronic acid.
I. A process as in H above, wherein the alcohol used for precipitating risedronic acid is selected from the group comprising methanol; ethanol; propanol; isopropyl alcohol; butanols such as 1-butanol, 2-butanol, isobutanol, tert. butanol and the like; pentanols such as 1-pentanol and the like; and mixtures thereof.
J. A process as in H above, wherein the purification step of risedronic acid comprises the steps of
   (a) dissolution of risedronic acid in water by addition of a base;
   (b) filtering the above aqueous solution
   (c) pH adjustment of the filtered solution by addition of inorganic or organic acids
   (d) optional addition of alcohol.
K. A process as in H above, wherein the purity of the risedronic acid obtained is more than 99%.
L. A process as in H above, wherein the process further comprises the step of preparing a salt of risedronic acid.
M. A process as in L above, wherein the salt of risedronic acid is monosodium hemipentahydrate salt.

### DESCRIPTION OF THE INVENTION

Before the present process and methods are described, it is to be understood that this invention is not limited to particular compounds, formulas or steps described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context clearly dictates otherwise. Thus, for example, reference to “a compound” includes a plurality of such compounds and reference to “the step” includes reference to one or more step and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

The present invention relates to a process for a process for preparing risedronic acid.

The present invention also relates to a process for purification of risedronic acid.

The present invention also relates to a process for preparing risedronic acid of high purity.

The present invention also relates to process for preparing risedronic acid, eliminating the use of aromatic hydrocarbons and linear or branched or cyclic aliphatic hydrocarbons.

The present invention also relates to a process for the preparation of risedronic acid which is cost-effective, ecofriendly and can be commercialized on a large scale with no prior art disadvantages of recovery or handling of the solvents or reactor fouling.

The present invention also relates to a process for the preparation of a salt of risedronic acid.

Accordingly, there is provided a process for preparing risedronic acid comprising the step of combining a 3-pyridyl acetic acid or a salt thereof, phosphorous acid, and a halophosporous compound selected from PCl₃, PCl_{S}, POCl₃, PBr₃, POBr₃, and PBr₅ in the presence of a diluent that is either a bicyclic aliphatic hydrocarbon or a substituted cyclic aliphatic hydrocarbon or a mixture thereof, in combination with a codiluent, that is orthophosphoric acid.

Accordingly, there is also provided a process for preparing a salt of risedronic acid comprising the steps of
(a) combining a 3-pyridyl acetic acid or a salt thereof, phosphorous acid, and a halophosporous compound selected from PCl₃, PCl_{S}, POCl₃, PBr₃, POBr₃, and PBr₅ in the presence of a diluent that is either a bicyclic aliphatic hydrocarbon or a substituted cyclic aliphatic hydrocarbon or a mixture thereof, in combination with a codiluent, that is orthophosphoric acid to form a reaction mixture;
(b) hydrolyzing the reaction mixture obtained in (a);
(c) optionally adding an alcohol to said reaction mixture to precipitate risedronic acid;
(d) purifying the risedronic acid.

Accordingly, there is also provided a purification step of risedronic acid which comprises the steps of
(a) dissolution of risedronic acid in water by addition of a base;
(b) filtering the above aqueous solution
(c) pH adjustment of the filtered solution by addition of inorganic or organic acids
(d) optional addition of alcohol.

The reactant used in the process of the present invention may be 3-pyridyl acetic acid or a salt thereof. The salt of 3-pyridyl acetic acid is either an inorganic salt or an organic salt. The organic salt of 3-pyridyl acetic acid may be prepared using monocarboxylic acids, dicarboxylic acids or alkyl or aryl sulfonates and the like. Inorganic salt of 3-pyridyl acetic acid can be prepared using hydrochloric acid, sulfuric acid, orthophosphoric acid or nitric acid and the like. A preferred salt of 3-pyridyl acetic acid is the hydrochloride salt of 3-pyridyl acetic acid. The hydrochloride salt may be formed by reacting 3-pyridyl acetic acid in toluene with aqueous solution of hydrochloric acid. This may be further purified in order to get a purer risedronic acid product.

The diluent that may be used in the process of the present invention is selected from a bicyclic aliphatic hydrocarbon or a substituted cyclic aliphatic hydrocarbon or a mixture thereof The substituted bicyclic aliphatic hydrocarbon may be selected from the group comprising decalin, tetralin and the like and mixtures thereof. The substituted cyclic aliphatic hydrocarbon may be selected from the group comprising methyl cyclohexane, trans-dimethyl cyclohexane, and cis-dimethyl cyclohexane and the like and mixtures thereof Preferred diluents of the process of the present invention may be selected from decalin and methylcyclohexane.

The halophosporous compound used in the process of the present invention is selected from the group comprising PCl₃, PCl_{S}, POCl₃, PBr₃, POBr₃, PBr₅ and the like and mixtures thereof. POCl₃ is the particularly preferred halophosporous compound.

The codiluents used in the process of the present invention is orthophosphoric acid which may also be known as phosphoric acid.

The alcohol used for precipitating risedronic acid may be selected from the group comprising methanol; ethanol; propanol; isopropyl alcohol; butanols such as 1-butanol, 2-butanol, isobutanol, tert. butanol and the like; pentanols such as 1-pentanol and the like; and mixtures thereof.

In the purification step of risedronic acid, the produced risedronic acid is dissolved in water by the addition of base. The base may be inorganic or organic such as sodium hydroxide; sodium bicarbonates; sodium carbonates; ammonia and the like thereof A particularly preferred base is the sodium hydroxide.

The process of the present invention provides risedronic acid of high purity. In an embodiment, the purity of the risedronic acid obtained by the process of the invention and purification process of the invention is more than 99%.

The risedronic acid prepared by the process of the invention may be converted into its pharmaceutical acceptable salt by methods known in the art. The salt of the risedronic acid which may be made by the process of the present invention may be selected from the group comprising sodium, potassium, calcium or magnesium and the like. A preferred salt is the sodium salt of risedronic acid i.e., risedronate sodium. A particularly preferred salt of risedronic acid is the monosodium hemipentahydrate salt i.e., risedronate sodium hemipentahydrate.

In the process of the present invention, 3-pyridyl acetic acid or a salt thereof, is used as a reactant. The 3-pyridyl acetic acid or its salt is reacted with phosphorous acid, and a halophosporous compound selected from PCl₃, PCl₅, POCl₃, PBr₃, POBr₃, and PBr₅ in the presence of a diluent that is either a bicyclic aliphatic hydrocarbon or substituted cyclic aliphatic hydrocarbon or a mixture thereof, in combination with a codiluent, that is orthophosphoric acid. Then the reaction mass is heated followed by addition of water. The process further involved separation of organic and aqueous layers; heating the aqueous layer containing the product at a temperature for example, 90-100° C. for 4-6 hrs, for hydrolysis. The process further involved isolating the crystalline risedronic acid monohydrate by adding an alcohol. The obtained risedronic acid monohydrate is further purified. The purification may involve dissolution of the risedronic acid in water by addition of a base; filtering of the aqueous solution; pH adjustment of the filtered solution by addition of inorganic or organic acids and optional addition of an alcohol. The purified risedronic acid is isolated as highly pure risedronic acid monohydrate which is directly converted to the desired pharmaceutical acceptable salt.

The following examples are intended to illustrate the scope of the present invention in all its aspects but not to limit it thereto.

### EXAMPLE 1

### A. Preparation of 3-pyridyl Acetic Acid Hydrochloride Salt

100 gm, 3-pyridyl acetic acid was dissolved in 250 ml toluene and 133 gm, 30% aqueous solution of hydrochloric acid was added at 30-40° C. temperature in 60 minutes. After completion of addition of hydrochloric acid, the temperature of reaction mass was raised to 90-95° C. and the temperature was maintained for 4-6 hrs with continuous removal of water azeotropically. After complete removal of water, the reaction mass was cooled to room temperature (25-30° C.) and the solid was collected by filtration under nitrogen atmosphere followed by washing with 633 ml of petroleum ether. The obtained cake was dried under vacuum at 30-40° C. 120 gm of dried 3-pyridyl acetic acid hydrochloride was obtained.

### B. Purification of 3-pyridyl Acetic Acid Hydrochloride

The obtained 3-pyridyl acetic acid hydrochloride salt (120 gm) was suspended in 300 ml ethyl acetate and the reaction mass was heated to 75-80° C. for 1 hr. The reaction mass was cooled to 28-30° C. and the product was collected by filtration under nitrogen atmosphere followed by washing with 2×20 ml ethyl acetate. The obtained cake was dried under vacuum at 30-40° C. giving 108 gm pure 3-pyridyl acetic acid hydrochloride.

### C. Preparation of Risedronic Acid

3-pyridyl acetic acid hydrochloride (100 gm, 0.5759 mole) was suspended in methyl cyclohexane (500 ml) along with phosphorous acid (142 gm, 1.73 moles). Water was removed by azeotropically and then orthophosphoric acid (170 gm, 1.91 mole) was added to the reaction mass. The reaction mass was further heated and water was removed azeotropically. After complete removal of water, the reaction mass was cooled to 90-92° C. and phosphorous oxychloride (162 ml, 1.73 mole) was added in 30 min.Then temperature was further raised to 95° C. and maintained for 20 hrs. After completion of 20 hrs, water (720 ml) was added to the reaction mass and the temperature of the reaction mass was further raised to 95° C. and maintained for 30 min. At same temperature, methyl cyclohexane layer was separated out and the lower aqueous layer was further heated at 95° C. for 5-6hrs. Now the reaction mass was cooled to 25-30° C. and isopropyl alcohol (1440 ml) was added slowly in 30-45 min. Then the reaction mass was further cooled to 5° C. and maintained for 1 hr. The precipitated product was collected by filtration and washed with chilled isopropyl alcohol (100 ml). The wet cake obtained was dried at 65-70° C. for 8-10 hrs to get 120 gm (Yield: 69.20%) as Risedronic acid monohydrate with HPLC purity more than 98%.

### EXAMPLE 2

3-pyridyl acetic acid (10 kg, 72 mole) was suspended in methyl cyclohexane (72 lit) and phosphorous acid (10 kg, 0.072 mole) in glass lined reactor. The mass was heated to remove water azeotropically. Then orthophosphoric acid (21.53 kg, 0.2414 mole) was added and the reaction mass was further heated to remove more water azeotropically. After complete removal of water, the reaction mass was cooled to 90-92° C. and phosphorous oxychloride (20.93 ltr, 0.2245 mole) was added in 30-45 min maintaining temperature in same range. The temperature was further raised to 95° C. and maintained for 20 hrs. After completion of 20 hrs, water (72 litr) was added and the reaction mass was further heated to 95° C. for 30 min. At same temperature, methyl cyclohexane layer was separated out. The lower aqueous layer was further heated at 95° C. for 5-6 hrs. Now the reaction mass was cooled to 25-30° C. and isopropyl alcohol (72 litr) was added slowly in 30-45 min. Then reaction mass was further cooled to 5° C. and maintained for 1 hr. The product was collected by filtration and washed with chilled isopropyl alcohol (10 ltr). The obtained wet cake was dried at 65-70° C. for 8-10 hrs to get 17-18 Kg (Yield: 78-81%) risedronic acid monohydrate having HPLC purity more than 98%

### EXAMPLE 3

3-pyridyl acetic acid (100 g, 0.729 mole) was suspended in decalin (800 mL) and phosphorous acid (179.3 gm 2.186 mole) and the mass was heated to remove water azeotropically. Then orthophosphoric acid (215.3 gm 2.419 mole) was added to it and the reaction mass was further heated to remove more water azeotropically. After complete removal of water, the reaction mass was cooled to 90-92° C., and phosphorous oxychloride (209.3 mL, 2.245 mole) was added in 30 min. Then temperature of reaction mass was raised to 95° C. and maintained for 20 hrs. After completion of 20 hrs, water (720 mL) was added in reaction mass and further heated for 30 min. Decalin layer was separated out at 90-95° C. The lower aqueous layer was heated at 95° C. for 5-6 hrs. Now the reaction mass was cooled to 25-30° C. and isopropyl alcohol (720 mL) was added slowly in 30-45 min at 25-30° C. Then reaction mass was further cooled to 5° C. and maintained for 1 hr. The product was collected by filtration and washed with chilled isopropyl alcohol (100 mL). The obtained wet cake was dried at 65-70° C. to get 170-180 gm. (Yield: 77-81%) risedronic acid monohydrate having HPLC purity more 98%.

### EXAMPLE 4

3-pyridyl acetic acid (100 gm (0.729 mole) was suspended in tetralin (700 ml) and phosphorous acid (179.3 gm (2.186 mole), and water was removed by azeotropically. Then orthophosphoric acid (215.3 gm, 2.419 mole) was added and the reaction mass was further heated to remove more water azeotropically. After complete removal of water, the reaction mass cooled to 90-92° C., and phosphorous oxychloride (209.3 mL, 2.245 mole) was added in 30 min. Then temperature was raised to 95° C. and maintained for 20 hrs. After completion of 20 hrs, water (720 ml) was added in reaction mass and the reaction mass was heated for 30 min at 90-95° C. At same temperature tetralin layer was separated out and the lower aqueous layer was heated at 95° C. for 5-6 hrs. Now the reaction mass was cooled to 25-30° C. and isopropyl alcohol (720 ml) was added slowly in 30-45 min. The reaction mass was further cooled to 5° C. and maintained for 1 hr. The product was collected by filtration and washed with chilled isopropyl alcohol (100 ml). The obtained wet cake was dried at 65-70° C. for 8-10 hrs to get 170-180 gm (Yield: 77-81%) risedronic acid monohydrate having HPLC purity more than 98%.

### EXAMPLE 5

The risedronic acid prepared in examples 1-4 was purified by the process given below:

### Purification of Risedronic Acid:

The risedronic acid (250 gm) having purity less than 99% is suspended in water (2000 ml) at 25-30° C. and 50% (w/w) sodium hydroxide solution (75 ml) was added at 25-30° C. The reaction mass was slowly heated to 50° C. and stirred for 30 min. Now activated carbon (20 gm) was added, stirred for 30 min at same temperature and filtered through hyflow bed. The filtrate was cooled to 25-30° C. and conc. HCl (89.7 ml) added in 30-45 min. Now isopropyl alcohol (500 ml) was added in 1 hr and aged for next 30 min. The reaction mass was cooled to 5° C. and further aged for 1 hr. The precipitated product was collected by filtration and washed with 1:1 isopropyl alcohol-water mixture (200 ml). The product was dried at 40-50° C. for 10-12 hrs to get 240 gm (Recovery: 96%) risedronic acid monohydrate having HPLC purity more than 99.5%.

### EXAMPLE 6

10 gm of [1-hydroxy-2-(3-pyridinyl)ethylidene] bisphosphonic acid, prepared in examples 1-4 and optionally purified in example 5 was suspended in 175 ml of water. Sodium hydroxide (1.5 gm) was added and the solution became clear within 1 hour. Acetonitrile was added to the solution. It was further cooled in ice bath for 2 hour. White colored solid product was filtered. It was washed with acetonitrile. It was dried under vacuum at room temperature for 2 hours to get hemi-pentahydrate monosodium salt of [1-hydroxy-2-(3-pyridinyl)ethylidene]bisphosphonic acid was obtained.

Although the invention has been described in terms of particular embodiments and applications, one of ordinary skill in the art, in light of this teaching, can generate additional embodiments and modifications without departing from the spirit of or exceeding the scope of the claimed invention. It should be emphasized that the above-described embodiments of the present invention, particularly any “preferred” embodiments, are merely possible examples of the invention of implementations, merely set forth for a clear understanding of the principles of the invention. Accordingly, it is to be understood that the drawings and descriptions herein are proffered by way of example to facilitate comprehension of the invention and should not be construed to limit the scope thereof.

1. A process for preparing risedronic acid comprising the step of combining a 3-pyridyl acetic acid or a salt thereof, phosphorous acid, and a halophosporous compound selected from PCl₃, PCl₅, POCl₃, PBr₃, POBr₃, and PBr₅ in the presence of a diluent that is either a bicyclic aliphatic hydrocarbon or a substituted cyclic aliphatic hydrocarbon or a mixture thereof, in combination with a codiluent, that is orthophosphoric acid.

2. The process of claim 1, wherein the 3-pyridyl acetic acid salt is either an inorganic salt or an organic salt.

3. The process of claim 2, wherein the 3-pyridyl acetic acid salt is a hydrochloride salt.

4. The process of claim 1, wherein the bicyclic aliphatic hydrocarbon is selected from the group comprising decalin, tetralin and the like and mixtures thereof

5. The process of claim 1, wherein the substituted cyclic aliphatic hydrocarbon is selected from the group comprising methyl cyclohexane, trans-dimethyl cyclohexane, cis-dimethyl cyclohexane and the like and mixtures thereof.

6. The process of claim 4, wherein the bicyclic aliphatic hydrocarbon is decalin.

7. The process of claim 5, wherein the substituted cyclic aliphatic hydrocarbon is methyl cyclohexane.

8. The process of claim 1, comprising the steps of:
(a) combining a 3-pyridyl acetic acid or a salt thereof, phosphorous acid, and a halophosporous compound selected from PCl₃, PCl₅, POCl₃, PBr₃, POBr₃, and PBr₅ in the presence of a diluent that is either a bicyclic aliphatic hydrocarbon or a substituted cyclic aliphatic hydrocarbon or a mixture thereof, in combination with a codiluent, that is orthophosphoric acid
(b) hydrolyzing the reaction mixture obtained in (a);
(c) optionally adding an alcohol to said reaction mixture to precipitate risedronic acid;
(d) purifying the risedronic acid.

9. A process as claimed in claim 8, wherein the alcohol used for precipitating risedronic acid is selected from the group comprising methanol; ethanol; propanol; isopropyl alcohol; butanols such as 1-butanol, 2-butanol, isobutanol, tert. butanol and the like; pentanols such as 1-pentanol and the like; and mixtures thereof.

10. A process as claimed in claim 8, wherein the purification step of risedronic acid comprises the steps of
(a) dissolution of risedronic acid in water by addition of a base;
(b) filtering the above aqueous solution
(c) pH adjustment of the filtered solution by addition of inorganic or organic acids
(d) optional addition of alcohol.

11. A process as claimed in claim 8, wherein the purity of the risedronic acid obtained is more than 99%.

12. A process as claimed in claim 8, wherein the process further comprises the step of preparing a salt of risedronic acid.

13. A process as claimed in claim 12, wherein the salt of risedronic acid is monosodium hemipentahydrate salt.
